(19) United States
(12) Patent Application Publication
(10) Pub. No.: US 2026/0326047 A1
(43) Pub. Date: Oct. 22, 2026

(54) FUNCTIONAL WATER PRODUCTION APPARATUS AND PRODUCTION METHOD

(71) Applicant: SOHBI ENVIRONMENTAL TECHNOLOGY LLC., Agatsuma-gun, Gunma (JP)

(72) Inventor: Tetsuo NOMURA, Agatsuma-gun, Gunma (JP)

(73) Assignee: SOHBI ENVIRONMENTAL TECHNOLOGY LLC., Agatsuma-gun, Gunma (JP)

(21) Appl. No.: 18/997,913

(22) PCT Filed: Jul. 21, 2023
(86) PCT No.: PCT/JP2023/026768

§ 371 Date: Jan. 23, 2025

(30) Foreign Application Priority Data
Jul. 28, 2022 (JP) 2022-120155

(51) Int. Cl. B01F 23/231; B01F 23/2375; B01F 101/00

(52) U.S. Cl. CPC B01F 23/231121; B01F 23/2375; B01F 2101/305; B01F 2215/0431

(57) ABSTRACT

Provided are an apparatus and a method for producing functional water having a ¹⁷O-NMR spectrum value significantly smaller than that of tap water. An upstream section of a channel is provided with a water structural change section 4 configured to change the ¹⁷O-NMR spectrum value of water. The water structural change section 4 is filled with ceramic particles 5. When packed in a closest possible manner, the ceramic particles 5 produce an increased resonance effect while colliding with running water. The ceramic particles 5 are made by granulating a mixture in which at least ash produced by burning bincho charcoal which contains a large amount of iron minerals is added to a ceramic material which is mainly composed of silica SiO₂ and alumina Al₂O₃ and which contains at least one of oxides of alkaline metals, oxides of alkaline earth metals, and oxides of the elements in groups 8 to 10. The burning temperature of the bincho charcoal is preferably 1250° C. to 1330° C., and the weight ratio of the bincho charcoal added to the ceramic material is preferably 0.5% to 5%. The particles are used which are obtained by mixing the ceramic material and the ash from the bincho charcoal and granulating the resultant mixture.

### TECHNICAL FIELD

The present invention relates to an apparatus and a method for producing functional water in which a liquid structure (average structure) is changed.

### BACKGROUND ART

Water with a changed structure (functional water), such as electrolyzed water, magnetic water, water with clusters reduced in size, and water containing nanobubbles, is known to behave differently from ordinary water, and many applications of such water have been reported.

Patent Literature 1 describes a method for producing functional water, including passing water through a microbubble generating section filled with mesh or fibers to generate microbubbles with a diameter of 500 nm or more in the water, bringing this water containing the microbubbles into contact with a ceramic made of at least one of oxides of alkali metals, oxides of alkaline earth metals, and oxides of the elements in groups 8 to 10 to dissolve the metal ions, and spraying this water containing the metal ions and the microbubbles from a nozzle while applying a size-reducing force to the microbubbles in the water, thereby turning the microbubbles into nano-sized bubbles with a diameter of less than 500 nm.

Patent Literature 2 proposes, as a generator of functional water usable in various technical fields, a structure in which a section filled with a block of a stainless steel net (stainless steel wool) and a section filled with a granular ceramic containing an oxide of an alkali metal, an oxide of an alkaline earth metal, and an oxide of at least one selected from the elements in groups 8 to 10 are arranged therein in series.

Patent Literature 3 discloses a stirrer made of a bincho charcoal. This literature states that the bincho charcoal has an adsorption effect to adsorb harmful substances and also a cluster decomposition effect and therefore has a function of turning water into soft water.

Non Patent Literature 1 reports that ceramic spheres are packed in a stainless steel cylinder in a closest-possible manner, and tap water is passed through the cylinder at a water pressure of 2 kgf and a flow rate of 15 L/min, so that a non-thermal effect of far infrared rays emitted from the ceramic makes water clusters smaller, and also that rice cooked with the functional water with the smaller clusters results in an increase in the amount of water absorbed and an increase in the sugar content.

Non Patent Literature 2 states that the presence of H₃O⁺ in the center of a regular dodecahedron as a water cluster structure is said based on the experimental fact that there are 10 sites for hydrogen bonding.

Non Patent Literature 3 states that gas-phase vibrational frequencies and intensities of water cluster structures of dimer to pentamer were calculated using molecular orbital calculations at the B3LYP/aug-cc-pVDZ level and the MP2/aug-cc-pVDZ level.

Non Patent Literature 4 describes a relationship between a two-dimensional LJ fluid and a water cluster structure.

Non Patent Literature 5 states that a cluster is a group of a certain number of water molecules assembled by hydrogen bonds, and these water molecules that make up a cluster stick together and separate from each other in picoseconds (10⁻¹² seconds), and that it was also denied that the size of the cluster can be measured using a 17O-NMR half-width.

Non Patent Literature 6 states that, when the cluster size of drinking water is measured using a ¹⁷O-NMR half-width, the cluster size cannot be accurately expressed due to the effects of the pH-dependent proton exchange rate and the coupling between ¹⁷O and protons.

Non Patent Literature 7 states that NMR analysis (¹⁷O-NMR chemical shift method) provides an observation time longer than the relaxation time of the rotational and translational motions of atoms, and therefore enables the average structure of a liquid to be examined.

Non Patent Literature 8 states that the results of ¹⁷O-NMR measurements of pure water and tap water using a nuclear magnetic resonance spectrometer showed that the half-width at half maximum for the pure water was 65.5 Hz and that for the tap water was 119.9 Hz.

### PRIOR ART LITERATURE

### Patent Literature

Patent Literature 1: Japanese Patent No. 6127196

Patent Literature 2: Japanese Unexamined Patent Application Publication No. 2002-85235

Patent Literature 3: Japanese Unexamined Patent Application Publication No. 2017-87176

### Non Patent Literature

Non Patent Literature 1: Hiroko MIZUHARA, Tadao IMANISHI, Toshihiko YASUDA, and Yoh SANO, “Improvement of Water Content and Sugar Content in Rice Cooked with Baked Ceramics Irradiating Ultrainfrared-treated Water”, Nippon Shokuhin Kagaku Kaisha Vol. 47, No. 8. 578 to 582(2000 )

Non Patent Literature 2: Tamio IKESHIYOUJI, “Quantum Molecular Dynamics Calculations of Water Clusters (Similarity and Heterogeneity Between Atomic Nuclei And Microclusters), Agency for Industrial Science and Technology, National Institute of Advanced Industrial Science and Technology, Cluster Science Group

Non Patent Literature 3: Mitsuhiro FUKUDA and Yuri HORINOUCHI, “Fundamental studies on the water structure—Vibrational analysis of water cluster by quantum chemical calculations”, 2001-52, 197,196,111

Non Patent Literature 4: Taku OHARA and Toshi AIHARA, “Molecular Dynamics Study on Cluster Structure of Water (Dependence of Cluster Size and Its Probability Distribution on Temperature and Density), Transactions of the JSME (in Japanese), Series B, Vol. 60, No. 570

Non Patent Literature 5: Tokyo Metropolitan Government Bureau of Life and Culture, “Scientific verification of the labeling of water activators” (February, 2005)

Non Patent Literature 6: Shoichi OKOUCHI, Yoshimasa ISHIHARA, Hiroshi ARAI, and Satoru UEHARA, “¹⁷-O and ²H-NMR of Drinking Water”, Journal of Japan Society on Water Environment, Vol. 16, No. 6, 409 to 415(1983 )

Non Patent Literature 7: Sin TAKAHASHI, Koryo KOJIMA, and Sankichi TAKAHASHI, “Liquid Structure of 1,4-Dioxane Aqueous Solution by 17O-NMR Chemical Shift Method”, Journal of Chemical Engineering of Japan, (March, 1998)

Non Patent Literature 8:“17O-NMR Measurement of Water Using Nuclear Magnetic Resonance Spectrometer”, Shizuoka Institute of Science and Technology, Application Note, Vol. 18, June, 2018

### SUMMARY OF INVENTION

### Technical Problem

In the apparatuses for producing the functional water disclosed in Patent Literature 1 and Patent Literature 2, the upstream section of the pipe is filled with the stainless steel wool and the downstream section of the pipe is filled with the ceramic. In other words, the microbubbles are generated in the upstream section, whereas the metal ions are dissolved in the water in the downstream section.

In the case where water mixed with microbubbles is first produced as described above, then it is difficult to cause a structural change in the water that would make the clusters smaller on the downstream side.

Stirring water with the stirrer made of bincho charcoal as described in Patent Literature 3 has little effect of causing a structural change in the water that would make the clusters smaller. In addition, bringing water into contact with the ceramic as described in Non Patent Literature 1 also has little effect of causing the structural change in the water.

Non Patent Literatures 2 to 4 describe the characteristics of clusters, but do not disclose any means for bringing about a structural change in ordinary tap water that would continuously make the clusters smaller.

Non Patent Literatures 5 and 6 state that it is inappropriate to express the size of water clusters with the ¹⁷O-NMR chemical shift method (half width at half maximum), but do not disclose any means for causing a structural change in ordinary tap water.

Non Patent Literatures 7 and 8 state that a structural change in water can be expressed with the ¹⁷O-NMR chemical shift method (half width at half maximum), but do not disclose any means for causing a structural change in ordinary tap water.

### Solution to Problem

The present inventor confirmed that, when water was brought into contact with a ceramic containing an oxide of an alkali metal, an oxide of an alkaline earth metal, or an oxide of at least one element selected from the group consisting of elements belonging to groups 8 to 10 at a certain flow rate (1.5 m/s to 2.0 m/s), a structural change occurred in the water due to a non-thermal effect of far-infrared rays emitted from the ceramic, but the structural change was not sufficient.

To address this, the present inventor mixed the above ceramic material with ash from burned bincho charcoal containing iron to form ceramic particles, and passed water through a channel filled with these ceramic particles at a flow rate of 1.5 m/s to 2.0 m/s, and consequently confirmed the occurrence of a major structural change because the 170-NMR spectrum values (half width) became 72.0 Hz (1.5 m/s) and 73.0 Hz (2.0 m/s).

However, with addition of unburned bincho charcoal, the ¹⁷O-NMR spectrum values were not greatly changed.

A functional water production apparatus according to the present invention based on the above fundings is a functional water production apparatus including a water structural change section provided at an upstream portion of a pipe constituting a water channel with one end used as a water inlet and the other end used as a water outlet, and configured to change a water structure, and a fine bubble generation section provided continuously downstream of the water structural change section, wherein the water structural change section is filled with ceramic particles obtained by granulating and burning a mixture of a ceramic material containing at least one of oxides of alkaline metals, oxides of alkaline earth metals, and oxides of elements in groups 8 to 10 and ash from burned bincho charcoal containing iron, and the fine bubble generation section is provided with a narrowed section configured to exert a cavitation effect.

The functional water production apparatus may have a structure in which a nozzle is arranged downstream of the narrowed section of the fine bubble generation section, and fine bubbles are generated at two stages by these narrowed section and nozzle.

In a method for producing functional water using the above functional water production apparatus, tap water is supplied to the water structural change section at a flow rate of 0.1 m/s or more from the one end of the pipe constituting the water channel, so that a structural change in the water in which the ¹⁷O-NMR spectrum value of the tap water becomes 97.5Hz or smaller is observed.

### Advantageous Effects of Invention

According to the present invention, further improved are the effects of functional water that have been conventionally recognized, such, for example, as softening hard water, enhancing the penetration ability of tap water to improve the cleaning effect of laundry, promoting water absorption in plants to maintain freshness, maintaining the health of livestock animals, improving water retention in use in cosmetics, and improving the extraction of herbal medicines.

In addition, according to the present invention, it was also found that a boiling point is 101° C. and a freezing point is −4° C. in addition to the effects having been recognized heretofore.

A simple operation of passing tap water through the apparatus of the present invention makes it possible to cause a structural change and therefore continuously produce functional water containing fine bubbles. Therefore, functional water can be used in many applications.

### BRIEF DESCRIPTION OF DRAWINGS

FIG. 1 is a diagram illustrating an internal structure of a functional water production apparatus according to the present invention.

FIG. 2 is a view of a nozzle attached to an outlet of the functional water production apparatus as viewed from an upstream side of a flow.

FIG. 3 is a table of samples and their ¹⁷O-NMR spectrum values.

FIG. 4 is a graph of two of the samples and their ¹⁷O-NMR spectrum values.

FIG. 5 is a certificate showing a test result for the amount of n-hexane dissolved in a sample (1).

FIG. 6 is a certificate showing a test result for the amount of n-hexane dissolved in a sample (2).

FIG. 7 is a certificate showing a test result for the amount of n-hexane dissolved in a sample (5).

FIG. 8 shows a comparative example in the case where tap water and functional water of the present invention were used as water for flower vases (first day).

FIG. 9 shows the comparative example in the case where the tap water and the functional water of the present invention were used as the water for flower vases (15th day).

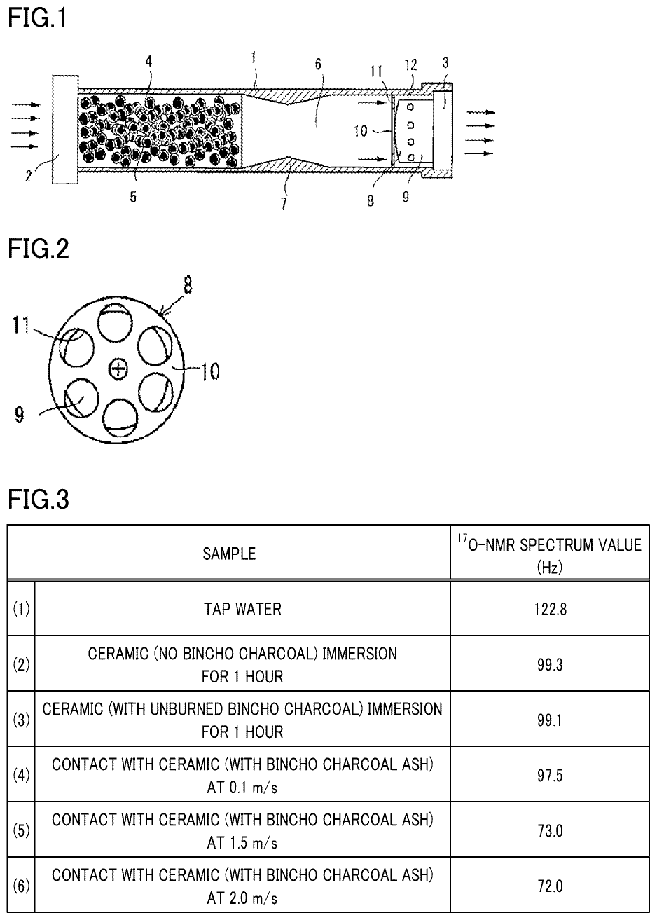

### DESCRIPTION OF EMBODIMENTS

In a functional water production apparatus, a water channel is formed inside a pipe 1 with one end of the pipe 1 as a water inlet 2 and the other end of the pipe 1 as a water outlet 3.

An upstream section of the channel is provided with a water structural change section 4 configured to change a ¹⁷O-NMR spectrum value of water. The water structural change section 4 is filled with ceramic particles 5. When being packed in a closest-possible manner, the ceramic particles 5 produce an increased resonance effect while colliding with running water.

As the ceramic particles 5, used are particles made by granulating a mixture in which at least ash produced by burning bincho charcoal which contains a large amount of iron minerals is added to a ceramic material which is mainly composed of silica SiO₂ and alumina Al₂O₃ and which contains at least one of oxides of alkaline metals, oxides of alkaline earth metals, and oxides of the elements in groups 8 to 10.

The burning temperature of the bincho charcoal is preferably 1250° C. to 1330° C., and the weight ratio of the bincho charcoal added to the ceramic material is preferably 0.5% to 5%. The particles are used which are obtained by mixing the ceramic material and the ash from the bincho charcoal and granulating the resultant mixture.

Ceramic particles formed by mixing powder of unburned bincho charcoal instead of the ash from the bincho charcoal and ceramic particles formed by mixing commercially available iron powder instead of the ash from the bincho charcoal were not able to make water particles sufficiently small.

It is also possible to add particles obtained by granulating and burning with ash from kibushi clay also added in addition to the bincho charcoal. The kibushi clay is a weathered granite product, kaolinite (Al₂Sl₂O₅(OH)₄), which has been buried and deposited together with swamp plants and driftwood, and contains trace amounts of catalytic metals such as Ni and Pt in addition to organic substances as compared to other minerals. For this reason, the kibushi clay is expected to cause a structural change in water that would change the ¹⁷O-NMR spectrum value.

Downstream of the water structural change section 4, a narrowed section 7 is provided, and a side downstream of the narrowed section 7 is configured as a fine bubble generation section 6. This fine bubble generation section 6 is a pressure release section in which the volume suddenly increases and fine bubbles are generated owing to the cavitation effect.

In the present embodiment, a nozzle 8 is provided inside the outlet 3 of the pipe 1. As also illustrated in FIG. 2, the nozzle 8 includes a cap portion 9 with a downstream side opened and a disc 10 attached to an upstream side of the cap portion 9. The disc 10 has multiple circular holes 11 formed therein, and the cap portion 9 also has small holes 12 connecting the outside and the inside of the cap portion 9.

When passing through the nozzle 8, water collides with each other to further reduce the sizes of bubbles generated due to the cavitation effect. Specifically, the diameter of the bubbles is reduced to smaller than 40 nms. In the present embodiment, the fine bubbles are generated at two stages, namely, the narrowed section 7 and the nozzle 8.

The diameter of the fine bubbles generated by the functional water production apparatus according to the present invention was measured by: preparing a solution by adding a spin trapping agent, namely, DMPO (5,5-dimethyl-1-pyrroline N-oxide); and observing the solution to measure the spectrum of DMPO-OH, which is a spin adduct resulting from the presence of nanobubbles, using an electron spin resonance (ESR) device.

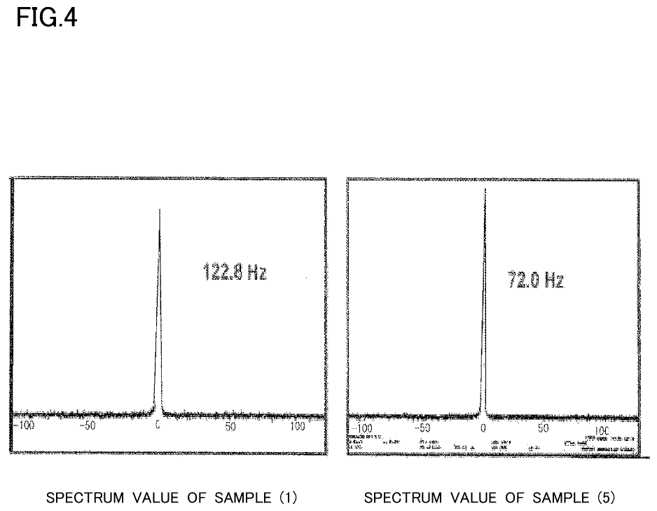

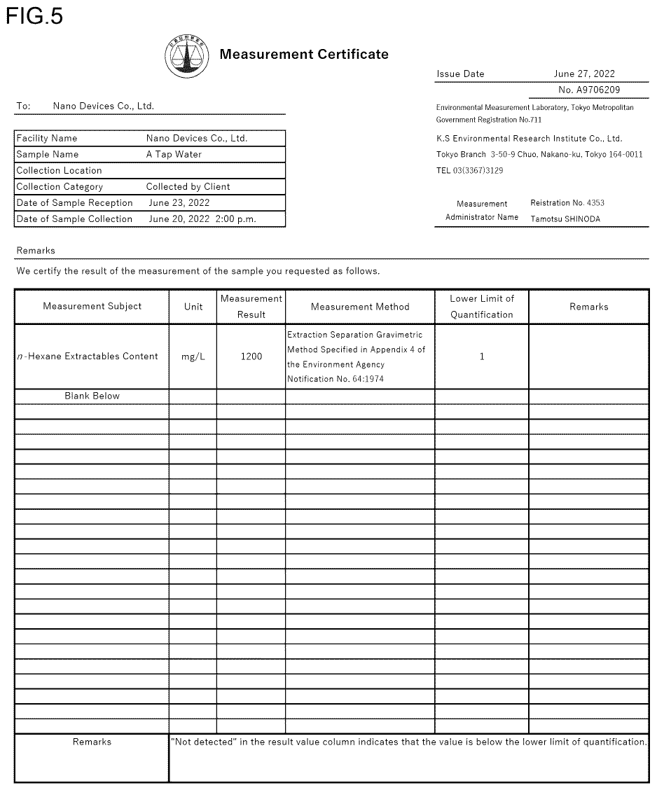

FIG. 3 is a table presenting measurement results of structural changes of sample water as the ¹⁷O-NMR spectrum values. FIG. 4 includes actual measurement graphs of the ¹⁷O-NMR spectrum values of samples (1) and (5) in FIG. 3.

The sample (1) is tap water, a sample (2) is water in which ceramic particles without addition of bincho charcoal ash were soaked in a container of tap water for 1 hour, a sample (3) is water in which ceramic particles without addition of bincho charcoal before burning (unburned bincho charcoal) were soaked in a container of tap water for 1 hour, a sample (4) is a case where ceramic particles with addition of bincho charcoal ash were packed in the cluster size reducing section of the apparatus of the present invention, and tap water was passed through it at a rate of 0.1 m/s, the sample (5) is a case where tap water was passed through it at a rate of 1.5 m/s, and a sample (6) is a case where tap water was passed through it at a rate of 2.0 m/s.

From the sample (2), it is found that the ¹⁷O-NMR spectrum value decreased simply by bringing tap water into contact with the ceramic particles, which indicates that a structural change of the water occurred. From the sample (3), it is found that the addition of the unburned bincho charcoal directly to the ceramic particles did not result in any significant structural change in the water as compared to the case where only the ceramic was used.

From the sample (4), it is found that when the ceramic particles containing the added bincho charcoal ash were brought into contact with the tap water at 0.1 m/s, the ¹⁷O-NMR spectrum value became smaller than when the particles were just immersed in the water. Furthermore, from the samples (5) and (6), it is found that the ¹⁷O-NMR spectrum value became smaller as the flow rate of the tap water increased. Here, the upper limit of the rate of the tap water is restricted to 2.0 m/s in order to prevent water hammer.

FIGS. 5 to 7 presents test results of the amounts of n-hexane dissolved (dissolution amount) in the sample water specified in FIG. 3.

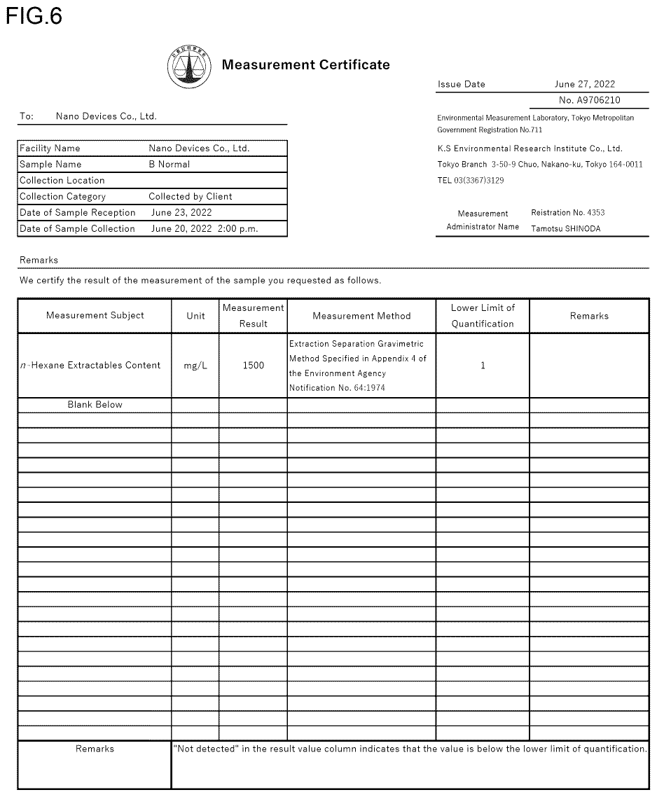

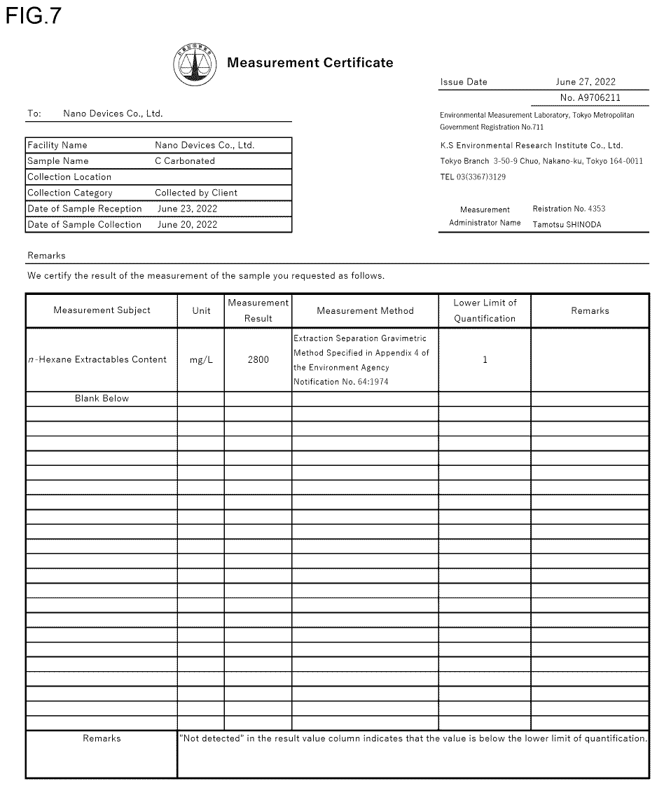

Tap water in FIG. 5 corresponds to the sample (1) in FIG. 3, water labeled as normal in FIG. 6 corresponds to the sample (2) in FIG. 3, and water labeled as carbonated in FIG. 7 corresponds to the sample (5) in FIG. 3. The term “carbonated” means that a trace amount of carbon dioxide was added to remove impurities from the water, and the water structure had a ¹⁷O-NMR spectrum value of 73.0 Hz.

It can be seen that a decrease (from 1200 mg/L to 2800 g/L) in the ¹⁷O-NMR spectrum value, which indicates a structural change in water, results in great improvement in the amount of n-hexane dissolved.

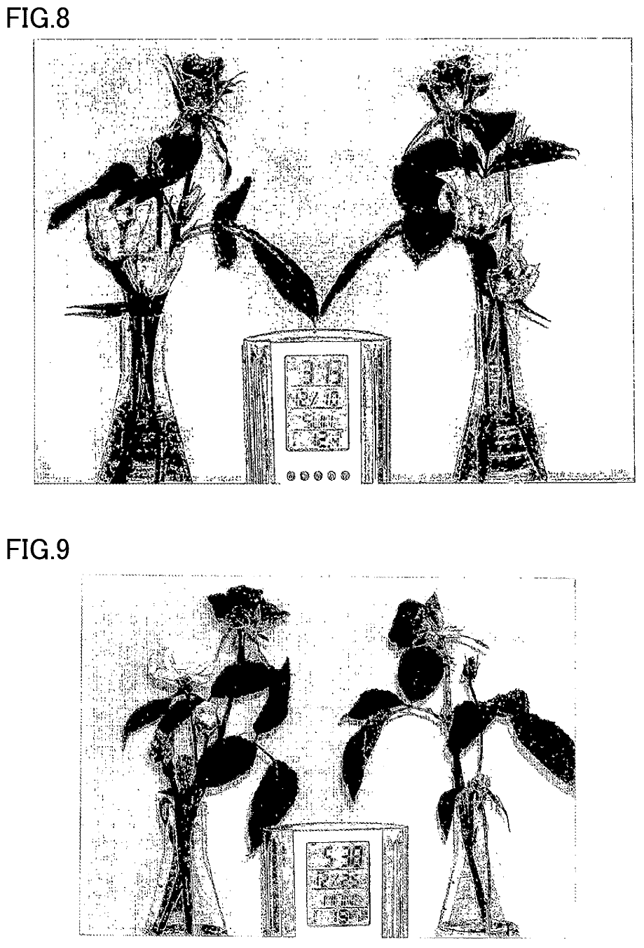

FIGS. 8 and 9 show a comparative example of using tap water and the functional water of the present invention as water in vases (on the 1st and 15th days). The vase on the left used the functional water, and the vase on the right used the tap water.

As is clear from the comparison of these photographs, flowers will last longer when the functional water of the present invention is used.

### REFERENCE SIGNS LIST

1 pipe
2 water inlet
3 water outlet
4 cluster size reduction section
5 ceramic particles
6 fine bubble generation section
7 narrowed section
8 nozzle
9 cap portion
10 disc
11 circular hole
12 small hole

1. A functional water production apparatus comprising:
a water structural change section provided at an upstream portion of a pipe constituting a water channel with one end used as a water inlet and the other end used as a water outlet and configured to change a water structure; and
a fine bubble generation section provided continuously downstream of the water structural change section, wherein
the water structural change section is filled with ceramic particles obtained by granulating and burning a mixture of a ceramic material containing at least one of oxides of alkaline metals, oxides of alkaline earth metals, and oxides of elements in groups 8 to 10 and ash from burned bincho charcoal containing iron, and
the fine bubble generation section is provided with a narrowed section configured to exert a cavitation effect.
